(19) United States
(12) Patent Application Publication
(10) Pub. No.: US 2024/0422176 A1
(43) Pub. Date: Dec. 19, 2024

(54) INFORMATION PROCESSING DEVICE AND INFORMATION PROCESSING METHOD

(71) Applicant: KABUSHIKI KAISHA TOSHIBA, Tokyo (JP)

(72) Inventors: Kosuke TODA, Yokohama Kanagawa (JP); Satoshi AOKI, Kawasaki Kanagawa (JP); Fukutomo NAKANISHI, Sumida Tokyo (JP); Tomonori MAEDA, Kawasaki Kanagawa (JP)

(73) Assignee: KABUSHIKI KAISHA TOSHIBA, Tokyo (JP)

(21) Appl. No.: 18/600,881

(22) Filed: Mar. 11, 2024

(30) Foreign Application Priority Data
Jun. 19, 2023 (JP) JP 2023-100307

(51) Int. Cl. H04L 9/40

(52) U.S. Cl. CPC H04L 63/1416; H04L 63/1425

(57) ABSTRACT

According to one embodiment, an information processing device includes: a pseudo trace generator configured to employ trace information of a first attack acquired when the first attack is executed on a first apparatus in a communication network and attack method information related to an attack method of a second attack on a second apparatus to generate pseudo trace information of the second attack; and a pseudo trace transmitter configured to transmit the pseudo trace information of the second attack to an evaluation target device which detects an attack based on trace information of the attack.

### CROSS REFERENCE TO RELATED APPLICATIONS

This application is based upon and claims the benefit of priority from the prior Japanese Patent Application No. 2023-100307, filed on Jun. 19, 2023, the entire contents of which are incorporated herein by reference.

### FIELD

The present disclosure relates to an information processing device and an information processing method.

### BACKGROUND

Security measures are implemented to detect or prevent cyber attacks on systems. In a method, performance of the security measure and setting thereof at system implementation are evaluated by actually executing an attack on the system and sending, to the security measure, communication data flowing through a network at the attack or a log acquired by an attack target host at the attack. However, actual execution of an attack on the system potentially adversely affects the system.

### BRIEF DESCRIPTION OF THE DRAWINGS

FIG. 1 is a diagram illustrating an example of a security measure system according to a first embodiment;

FIG. 2 is a diagram illustrating an example of the configuration of a monitoring target system in which an evaluation target device and a security measure evaluation device are implemented;

FIG. 3 is a functional block diagram illustrating an example of the configuration of the security measure evaluation device;

FIG. 4 is a diagram illustrating an example of an attack scenario;

FIG. 5 is a diagram illustrating an example of network configuration information;

FIG. 6 is a diagram illustrating exemplary attack trace data stored in an attack trace storage;

FIG. 7 is a diagram illustrating an example of trace information in the attack trace data in FIG. 6;

FIG. 8 is a diagram illustrating an example of pseudo trace information generated from the trace information based on parameters;

FIG. 9 is a diagram illustrating specific examples of the trace information and the pseudo trace information;

FIG. 10 is a flowchart illustrating an example of the procedure of processing by the security measure evaluation device according to the present embodiment;

FIG. 11 is a flowchart illustrating an example of the processing procedure of generating the pseudo trace information in a case where the trace information is communication data;

FIG. 12 is a flowchart illustrating an example of the processing procedure of generating the pseudo trace information in a case where the trace information is a log;

FIG. 13 is a functional block diagram illustrating an example of the configuration of a security measure evaluation device according to a second embodiment;

FIG. 14 is a diagram illustrating an example of evaluation result data;

FIG. 15 is a flowchart illustrating an example of the procedure of processing by the security measure evaluation device according to the second embodiment;

FIG. 16 is a flowchart illustrating an example of the processing procedure of generating an evaluation result in Example 1 of the second embodiment;

FIG. 17 is a flowchart illustrating an example of the processing procedure of generating an evaluation result in Example 2 of the second embodiment;

FIG. 18 is a flowchart illustrating an example of the processing procedure of generating an evaluation result in Example 3 of the second embodiment; and

FIG. 19 illustrates a hardware configuration of an information processing device according to each embodiment.

### DETAILED DESCRIPTION

According to one embodiment, an information processing device includes: a pseudo trace generator configured to employ trace information of a first attack acquired when the first attack is executed on a first apparatus in a communication network and attack method information related to an attack method of a second attack on a second apparatus to generate pseudo trace information of the second attack; and a pseudo trace transmitter configured to transmit the pseudo trace information of the second attack to an evaluation target device which detects an attack based on trace information of the attack.

The present embodiment will be described below with reference to the accompanying drawings.

### First Embodiment

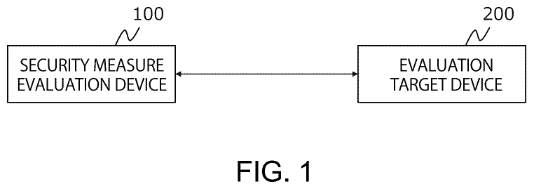

FIG. 1 illustrates an example of a security measure system according to a first embodiment. The security measure system in FIG. 1 includes a security measure evaluation device 100 and an evaluation target device 200. The security measure evaluation device 100 corresponds to an information processing device according to the present embodiment. The security measure evaluation device 100 evaluates security measures in a monitoring target system, such as whether the evaluation target device 200 as a security function in the monitoring target system can detect or prevent an attack. The monitoring target system is a communication network including one or a plurality of apparatuses (or appliances). The communication network is, for example, a local area network such as a wireless LAN or an Ethernet.

The evaluation target device 200 may be implemented as part of the monitoring target system or may be implemented as software on an apparatus (host) in the monitoring target system. Alternatively, the evaluation target device 200 may be separated from the monitoring target system, and in this case, the evaluation target device 200 may be directly connected to the security measure evaluation device 100 through a communication cable or the like.

The evaluation target device 200 is a device in charge of executing a security function to detect or prevent an attack based on communication data acquired from the communication network or a host log acquired from an apparatus. The function to detect or prevent an attack is, for example, a function to detect anomalous traffic or a function to prevent anomalous traffic. Specific examples of the evaluation target device 200 include a network based intrusion detection system (IDS) capable of detecting an attack, a network based intrusion prevention system (IPS) capable of detecting and preventing an attack, and an attack detection tool (log detection tool) as software capable of detecting an attack.

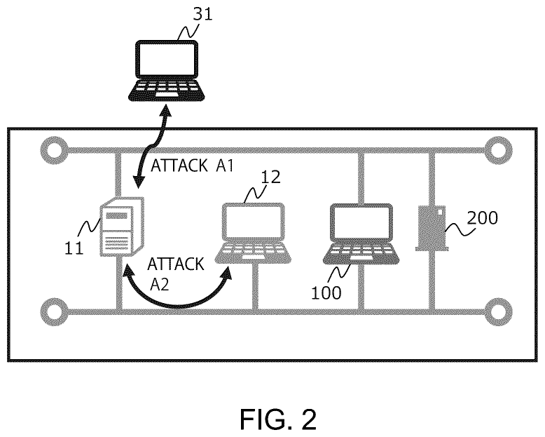

FIG. 2 illustrates an example of the configuration of the monitoring target system in which the evaluation target device 200 and the security measure evaluation device 100 are implemented. The monitoring target system is configured as a communication network. In this example, the evaluation target device 200 is a network based IDS. The system in FIG. 2 is configured as a local area network. Two apparatuses (hosts) are deployed in addition to the evaluation target device 200 and the security measure evaluation device 100 in the communication network. One of the apparatuses is a gateway (GW) 11, and the other is an optional apparatus 12. The apparatus 12 may be a personal computer (PC), an industrial apparatus, or any other apparatus. In the diagram, a device (attacker device) 31 operated by a malicious person to attack the communication network in FIG. 2 is illustrated outside the network as a reference. Consider a case where the attacker device 31 sends (attack A1) communication data into the communication network for an attack, compromises the gateway 11, and attacks (attack A2) the apparatus 12 through the gateway 11. With correct security settings (security measures) implemented on the evaluation target device 200, the evaluation target device 200 can acquire communication data flowing through the communication network at an attack and detect the attack by the attacker device 31 based on the acquired communication data. The communication data acquisition may be performed by using packet capturing software or the like. According to the present embodiment, when it is assumed that such an attack occurs, it is possible to evaluate in advance whether the security measure evaluation device 100 can detect or prevent the attack without actually attacking the communication network (attacking the GW 11 and the apparatus 12). In the evaluation, a monitoring target apparatus (the GW 11 and the apparatus 12 in the example illustrated in FIG. 2) does not necessarily need to be actually deployed in the communication network.

Specifically, the security measure evaluation device 100 generates pseudo communication data or a pseudo log (pseudo trace information to be described later) when it is assumed that an attack occurs based on one or more attack scenarios, transmits the pseudo communication data or the pseudo log to the evaluation target device 200, and causes the evaluation target device 200 to perform attack detection operation based on the pseudo communication data or the pseudo log. One of main characteristics of the present embodiment is a method of generating such pseudo communication data or a pseudo log (pseudo trace information).

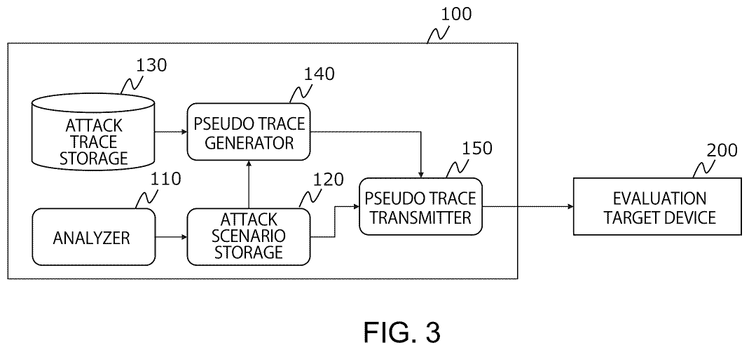

FIG. 3 is a functional block diagram illustrating an example of the configuration of the security measure evaluation device 100.

The security measure evaluation device 100 includes an analyzer 110, an attack scenario storage 120, an attack trace storage 130, a pseudo trace generator 140, and a pseudo trace transmitter 150.

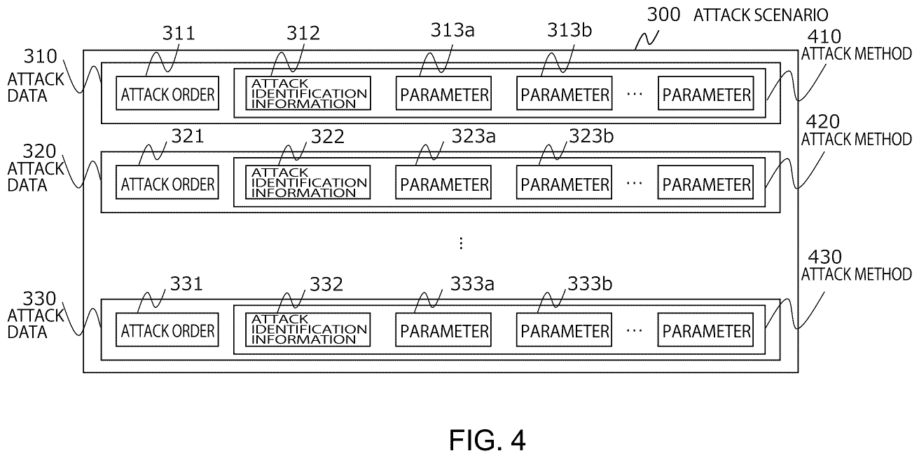

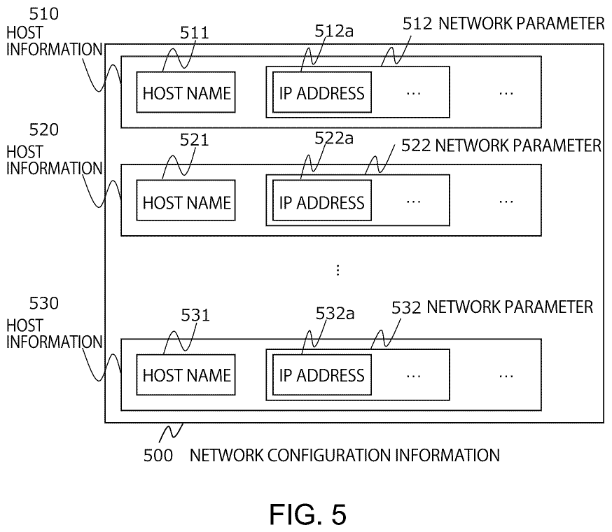

The analyzer 110 acquires an attack scenario 300 (refer to FIG. 4 to be described later) and network configuration information 500 (refer to FIG. 5 to be described later). The attack scenario 300 may be, for example, generated by another device based on system configuration information or vulnerability information of the monitoring target system and acquired by the analyzer 110. Alternatively, the analyzer 110 may acquire the attack scenario 300 input by a user through an operation device. The attack scenario 300 may be a single scenario or a plurality of scenarios. The analyzer 110 may acquire the network configuration information 500 from the user through the operation device or from a device that manages network configuration information.

FIG. 4 illustrates an example of the attack scenario 300. The attack scenario 300 includes a plurality of pieces of attack data 310 to 330. The attack data 310 includes an attack order 311 and an attack method 410. The attack method 410 includes information related to an attack method or an attack procedure, and more specifically, includes attack identification information 312 and one or a plurality of parameters 313a, 313b, . . . The parameters 313a, 313b, . . . are collectively referred to as parameters 313 when not distinguished from one another.

The other attack data 320 and 330 and the like have the same configuration as the attack data 310. Specifically, the attack data 320 includes an attack order 321 and an attack method 420. The attack method 420 includes attack identification information 322 and one or a plurality of parameters 323a, 323b, . . . The parameters 323a, 323b, . . . are collectively referred to as parameters 323 when not distinguished from one The attack data 330 includes an attack order 331 and an attack another. method 430. The attack method 430 includes attack identification information 332 and one or a plurality of parameters 333a, 333b, . . . The parameters 333a, 333b, . . . are collectively referred to as parameters 333 when not distinguished from one another.

The attack orders 311 to 331 are information for determining the order of an attack according to the attack scenario 300. For example, in a case where the attack A1 in FIG. 2 is simulated with the attack data 310 and the attack A2 is simulated with the attack data 320, the attack order 311 indicates “1” and the attack order 321 indicates “2”.

The attack identification information 312 to 332 is information with which attack contents are identifiable. The attack identification information 312 to 332 may be identification information identifying an attack module implemented on a penetration test tool or may be identification information identifying a penetration test script. Alternatively, the attack identification information 312 to 332 may be simply IDs with which a plurality of pieces of attack data are identified from one another.

The parameters 313 to 333 are information that needs to be designated to execute an attack and are parameters designated at an attack. Each parameter may include all or at least one of, for example, an IP address, a port number, a username, a password, and an attack target type. For example, the parameters 313 to 333 that designate the source IP address of the attacker device 31 and the destination address of the GW 11 and the like are used in a case where one or more packets used when the GW 11 is attacked by the attacker device 31 in FIG. 2 based on the attack data 310 are generated as pseudo communication data (pseudo trace information to be described later). In a case where an attack is executed in a plurality of phases (for example, the GW 11 is attacked in the first phase and the apparatus 12 is attacked in the next phase), the attack data 310 to 330 may correspond to the respective phases. In this case, the parameters 313 to 333 are used in a manner corresponding to the respective phases. Each attack data includes a plurality of parameters in the example illustrated in FIG. 4 but may include only one parameter. Alternatively, the attack data may include no parameter. For example, a function (computer program) to generate pseudo trace information by rewriting trace information to be described later may be stored in place of parameters.

FIG. 5 illustrates an example of the network configuration information 500. As illustrated in FIG. 5, the network configuration information 500 includes one or a plurality of pieces of host information 510 to 530. The host information 510 to 530 is information related to one or a plurality of apparatuses or devices present in the communication network. For example, in the case of the network in FIG. 2, the GW 11, the apparatus 12, the IDS 200, and the security measure evaluation device 100 may be each included as host information. The configuration of the communication network can be specified by this set of host information.

More specifically, the host information 510 includes a host name 511 and one or more network parameters 512. Each network parameter 512 is information related to a network to which a host of the host information 510 is connected. The network parameter 512 includes one or a plurality of pieces of information such as an IP address 512a of the host. Information other than an IP address is, for example, a MAC address.

The other host information 520 and 530 and the like have the same configuration as the host information 510. Specifically, the host information 520 includes a host name 521 and one or more network parameters 522. Each network parameter 522 includes one or a plurality of pieces of information such as an IP address 522a of a host. The host information 530 includes a host name 531 and one or more network parameters 532. Each network parameter 532 includes one or a plurality of pieces of information such as an IP address 532a of a host.

The attack scenario storage 120 stores the attack scenario 300 and the network configuration information 500 acquired by the analyzer 110.

The attack scenario storage 120 may determine, by using the network configuration information 500, whether the evaluation target device 200 can monitor an attack indicated by the attack data 310 or the like, and may store result information of the determination. The evaluation target device 200 capable of monitoring an attack can acquire communication data flowing through the communication network or acquire a log at the own device at the attack. For example, the evaluation target device 200 can monitor an attack in a case where the evaluation target device 200 is a network based IDS and can acquire communication data of a monitoring target apparatus, which flows through the communication network at an attack.

The attack trace storage 130 stores trace data (attack trace data) of a plurality of attacks corresponding to the attack identification information 312 to 332. The attack trace data is, for example, data of an attack actually executed on the communication network in the past. The attack may be an experimentally executed attack. The attack trace data may be data of a virtual attack produced by assuming an actual attack. An attack on the communication network may be successful or unsuccessful or may be both. An apparatus targeted by an attack according to trace data of the attack may be currently present or not in the communication network.

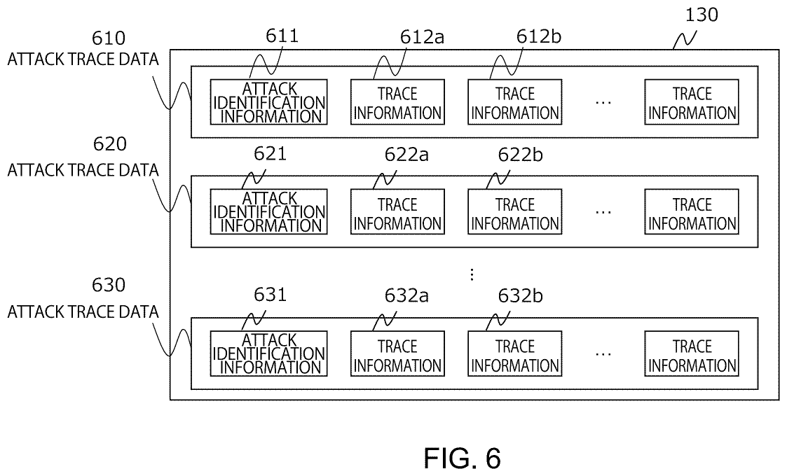

FIG. 6 illustrates exemplary attack trace data stored in the attack trace storage 130.

The attack trace storage 130 includes a plurality of pieces of attack trace data 610 to 630.

The attack trace data 610 includes attack identification information 611 and one or a plurality of pieces of trace information 612 (612a, 612b, . . . ). The attack trace data 610 corresponds to the attack data 310 in FIG. 4, and the attack identification information 611 has the same value as the attack identification information 312 of attack data in FIG. 4. The attack scenario 300 may be produced with reference to the attack trace data 610 in FIG. 6 after the attack trace data 610 is acquired. The trace information 612 is information generated at an attack and is, for example, communication data (communication data in a case where an attack is successful or unsuccessful) flowing through the communication network, or a log remaining in a host. The communication data is acquired by a capturing device or capturing software installed on the communication network. The data format of the trace information 612 may be optional and for example, the PCAP format or the TXT format. The trace information 612 (612a, 612b, . . . ) corresponds to the parameters 313 (313a, 313b, . . . ) in FIG. 4, and pseudo trace information is generated by rewriting the trace information 612a and 612b with the parameters 313a and 313b as described later.

The other attack trace data 620 and 630 and the like have the same configuration as the attack trace data 610. Specifically, the attack trace data 620 includes attack identification information 621 and one or a plurality of pieces of trace information 622 (622a, 622b, . . . ). The attack trace data 630 includes attack identification information 631 and one or a plurality of pieces of trace information 632 (632a, 632b, . . . ).

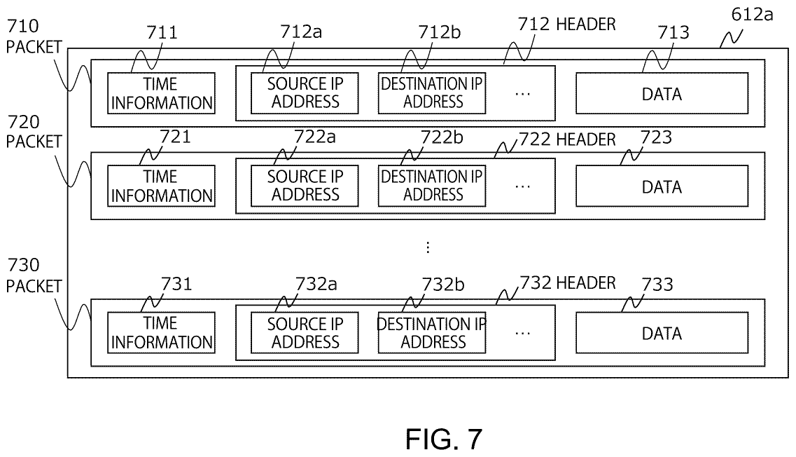

FIG. 7 illustrates an example of the trace information 612a among the plurality of pieces of trace information 612 (612a, 612b, . . . ) in the attack trace data 610 in FIG. 6. In this example, the trace information 612a is communication data flowing through the communication network at an attack. More specifically, the trace information 612a includes a plurality of packets 710 to 730.

The packet 710 includes time information 711, a header 712, and data 713. The header 712 includes a plurality of pieces of information such as a source IP address 712a and a destination IP address 712b. The data 713 is a body part of communication data. The other packets 720 and 730 have the same configuration as the packet 710. Specifically, the packet 720 includes time information 721, a header 722, and data 723. The header 722 includes a plurality of pieces of information such as a source IP address 722a and a destination IP address 722b. The packet 730 includes time information 731, a header 732, and data 733. The header 732 includes a plurality of pieces of information such as a source IP address 732a and a destination IP address 732b.

The pseudo trace generator 140 sequentially selects attack data in the attack scenario storage 120, selects attack trace data corresponding to the selected attack data (attack trace data having the same attack identification information as the selected attack data) in the attack trace storage 130, and generates pseudo trace data. More specifically, for example, in a case where the attack data 310 and the attack trace data 610 are selected, pseudo trace information is generated by rewriting the trace information 612a in the attack trace data 610 based on the parameter 313a of the corresponding attack data 310. The pseudo trace information is the trace information 612a rewritten to simulate an actual attack. For example, when it is assumed that an attack is executed in accordance with the parameter 313a, the pseudo trace information is generated by changing a source IP address and a destination IP address in the trace information 612a to simulate communication data flowing at an actual attack. However, in a case where the attack trace data 610 is trace acquired upon an attack on the same apparatus as in the attack data 310, a source IP address and a destination IP address in the trace information 612a match those of the parameter 313a.

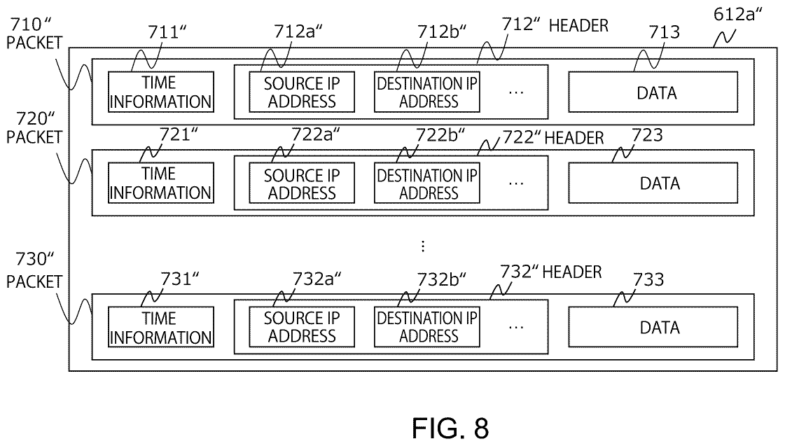

FIG. 8 illustrates an example of pseudo trace information 612a″ generated from the trace information 612a based on the parameter 313a. The time information 711 to 731 in FIG. 7 are changed to the current time and denoted by 711″ to 731″, respectively. In addition, the header 712 to 732 in FIG. 7 are changed to headers 712″ to 732″, respectively, based on the parameter 313a. The headers 712″ to 732″ include source IP addresses 712a″ to 732a″, destination IP address 712b″ to 732b″, port numbers, and the like, respectively. In the present example, it is assumed that the data 713 to 733 is the same values as the data in FIG. 7 (data is not rewritten), but the data 713 to 733 can be rewritten from the data in FIG. 7.

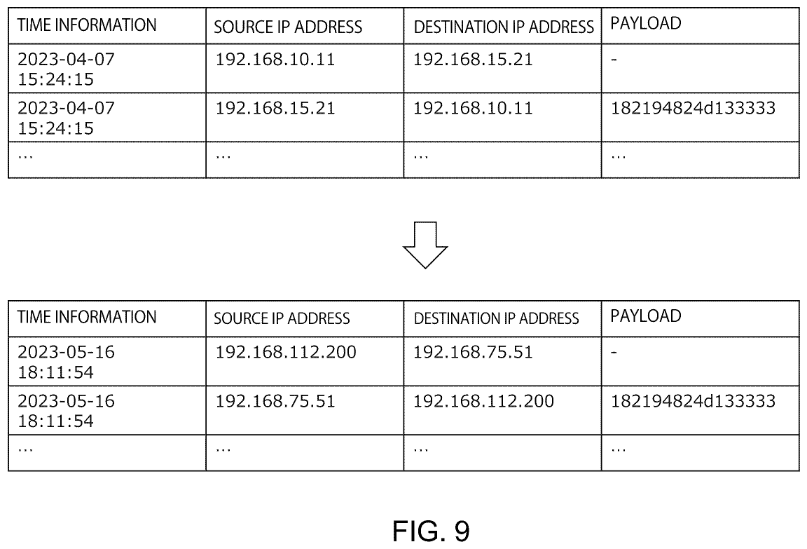

FIG. 9 illustrates specific examples of the trace information 612a and the pseudo trace information 612a″. In FIG. 9, the upper diagram illustrates a specific example of the trace information 612a, and the lower diagram illustrates a specific example of the pseudo trace information 612a″. Time information, source IP addresses, and destination IP addresses are rewritten. Payload (data) is not rewritten. In each illustrated example, packets are transmitted and received between two apparatuses (for example, an attacking apparatus and an attacked apparatus), the source IP addresses and the destination IP addresses are interchanged between a packet of the first row and a packet of the second row.

Similarly, pseudo trace information is generated by changing the trace information 612b . . . in the attack trace data 610 based on the parameter 313b . . . of the corresponding attack data. In this manner, the pseudo trace generator 140 generates a set of pieces of pseudo trace information corresponding to the trace information 612a, 612b, . . .

As described above, the pseudo trace generator 140 generates a set of pieces of pseudo trace information for each attack data of the attack scenario by using the corresponding attack trace data.

The pseudo trace transmitter 150 sequentially transmits the set of pieces of pseudo trace information to the evaluation target device 200 in accordance with the corresponding attack orders 311 to 331. In transmission of the pseudo trace information, one or a plurality of pieces of the trace information may be transmitted at a time. In a case where one piece of the trace information is transmitted at a time, a detection result of the evaluation target device 200 can be known at each time, and thus evaluation can be easily performed. In a case where all pieces of the trace information for the respective pieces of attack data are transmitted at a time, processing by the present device 100 can be ended upon the transmission and thus no waiting time is needed.

When the pseudo trace information is transmitted (fed) to the evaluation target device 200, the evaluation target device 200 may be implemented in the communication network (actual device environment) or isolated from the communication network. Even in a case where the evaluation target device 200 is implemented in the communication network, only normal communication data flows through the communication network and the pseudo trace information is transmitted only to the evaluation target device 200, and thus any other apparatus in the communication network is not affected. Accordingly, without actually attacking an attack target apparatus, it is possible to evaluate whether an attack can be detected by transmitting the pseudo trace information simulating an attack on the apparatus to the evaluation target device 200. In a case where the evaluation target device 200 is isolated from the communication network, the evaluation can be performed without work of actually establishing a simulated environment. In this case as well, without actually attacking an attack target apparatus, it is possible to evaluate whether an attack can be detected at the evaluation target device 200.

### Processing Procedure

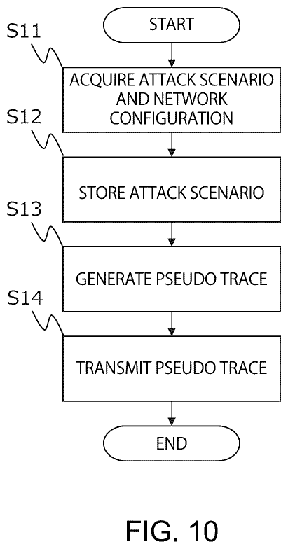

FIG. 10 is a flowchart illustrating an example of the procedure of processing by the security measure evaluation device 100 according to the present embodiment.

The analyzer 110 acquires the attack scenario 300 and the network configuration information 500 (step S11 in FIG. 10). The attack scenario 300 may be in the JSON format, the XML format, or the like. The attack scenario 300 may include no attack order but include an attack method for each attack order. The network configuration information 500 may be in the JSON format, the XML format, or the like. The network configuration information 500 may be input from the user through the operation device.

The attack scenario storage 120 stores the attack scenario 300 acquired by the analyzer 110 (step S12 in FIG. 10). In this case, whether an attack indicated by each attack data of the attack scenario can be monitored by the evaluation target device 200 may be stored. An example of determination of whether the monitoring is possible is described above.

The pseudo trace generator 140 generates pseudo trace information corresponding to each attack data in the attack scenario 300 by using the corresponding attack trace data in the attack trace storage 130 (step S13 in FIG. 10). The pseudo trace information corresponds to communication data flowing through the communication network or a log generated at a host when it is assumed that an attack is executed in accordance with the parameters of the attack data.

The pseudo trace transmitter 150 transmits the pseudo trace information generated at step S13 to the evaluation target device 200 in accordance with the attack order of attack data, thereby causing the evaluation target device 200 to execute detection operation (step S14 in FIG. 10). The evaluation target device 200 obtains a detection result that an attack is detected or no attack is detected. The detection result can take various forms such as storage as a log in the evaluation target device 200 or outputting as an alert. The log of the detection result by the evaluation target device 200 may be read and displayed on a screen by the user through the operation device.

### Method of Generating Pseudo Trace Information when Trace Information is Communication Data

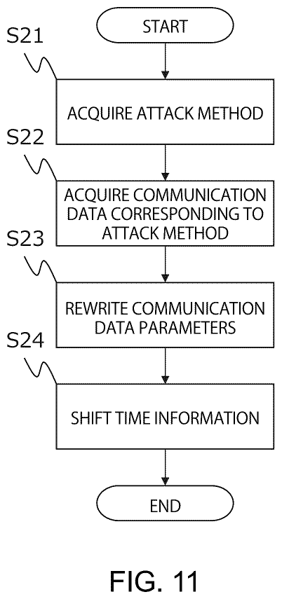

FIG. 11 is a flowchart illustrating an example of the processing procedure of generating pseudo trace information by the pseudo trace generator 140 based on the attack data 310 included in the attack scenario 300 in a case where trace information is communication data. The processing in FIG. 11 may be performed in a case where an attack represented by each attack data of the attack scenario is an attack that can be monitored by the evaluation target device 200 and trace information is communication data. The following description is made with an example of the procedure of processing for the attack data 310 included in the attack scenario 300, but is the same for the attack data 320 and 330 as well.

First, the pseudo trace generator 140 acquires the attack method 410 included in the attack data 310 (step S21 in FIG. 11).

Subsequently, the pseudo trace generator 140 acquires, from the attack trace storage 130, communication data that is trace information corresponding to the attack identification information 312 included in the attack method 410 (step S22 in FIG. 11).

Subsequently, the pseudo trace generator 140 converts parameters such as the source IP address and destination IP address of a packet included in the communication data (trace information) based on the parameters 313 included in the attack method 410 (step S23 in FIG. 11). In a case where a plurality of packets are included in the communication data (trace information), parameters such as the source IP address and destination IP address of each packet are converted based on the parameters 313. The conversion may be performed, for example, in accordance with a correspondence table of IP addresses, which is produced based on the parameters 313 and each packet included in the communication data.

Subsequently, the pseudo trace generator 140 shifts the time information of the packet included in the communication data (trace information) to the current time (step S24 in FIG. 11). In a case where a plurality of packets are included in the communication data (trace information), the time information of each packet is shifted to the current time.

Through the above-described processing, it is possible to generate, as pseudo trace information, communication data simulating communication data generated at an attack.

### Method of Generating Pseudo Trace Information when Trace Information is Log

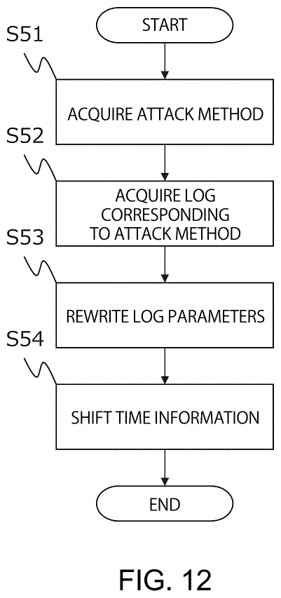

FIG. 12 is a flowchart illustrating an example of the processing procedure of generating pseudo trace information by the pseudo trace generator 140 based on the attack data 310 included in the attack scenario 300 in a case where trace information is a log. The processing in FIG. 12 may be performed in a case where an attack represented by each attack data of the attack scenario is not an attack that can be monitored by the evaluation target device 200 through a network and trace information is a log. The following description is made with an example of the procedure of processing for the attack data 310 included in the attack scenario 300, but is the same for the attack data 320 and 330 as well.

First, the pseudo trace generator 140 acquires the attack method 410 included in the attack data 310 (step S51 in FIG. 12).

Subsequently, the pseudo trace generator 140 acquires a log (host log) that is trace information corresponding to the attack identification information 312 included in the attack method 410 from the attack trace storage 130 (step S52 in FIG. 12). The log may be a single log or a plurality of logs. The log may be a log in a case where a trial attack is successful or unsuccessful.

Subsequently, the pseudo trace generator 140 converts parameters included in the host log based on the parameters 313 included in the attack method 410 (step S53 in FIG. 10). The converted parameters may be information that identifies a host, such as at least one of an IP address and a MAC address.

Subsequently, the pseudo trace generator 140 shifts the time information included in the log to the current time (step S54 in FIG. 10). In a case where a plurality of logs are available, the time information of each log is shifted to the current time.

Through the above-described processing, it is possible to generate, as pseudo trace information, a host log that simulates a host log generated at an attack.

### Example of First Embodiment

The evaluation target device 200 is a network based IDS (hereinafter referred to as NIDS) or a network based IPS (hereinafter referred to as NIPS). Communication data is generated as pseudo trace information based on communication data for a case where an attack is successful or unsuccessful and the attack scenario, and transmitted to the NIDS or the NIPS. Specifically, the pseudo trace generator 140 generates pseudo communication data (the pseudo trace information) based on attack data included in the attack scenario 300. Then, the pseudo trace transmitter 150 sends the pseudo communication data (the pseudo trace information) to the evaluation target device 200 (NIDS or NIPS). A log or alert generated at the NIDS or NIPS when fed with the pseudo communication data is manually analyzed to evaluate whether an attack is detected by the NIDS or detected and prevented by the NIPS. Accordingly, it is possible to evaluate whether the installation place and settings of the NIDS or NIPS or an attack detection method is appropriate.

As described above, according to the present embodiment, without actually attacking the monitoring target system (communication network), it is possible to evaluate whether settings of an evaluation target device are appropriate by generating pseudo trace information that simulates communication data for a case where it is assumed that an attack is executed. Specifically, the pseudo trace information generated when an attack is executed according to the attack scenario is generated based on attack trace data acquired in advance and fed to the evaluation target device. Accordingly, without actually attacking the monitoring target system, it is possible to evaluate whether security measures of the monitoring target system appropriately function.

### Second Embodiment

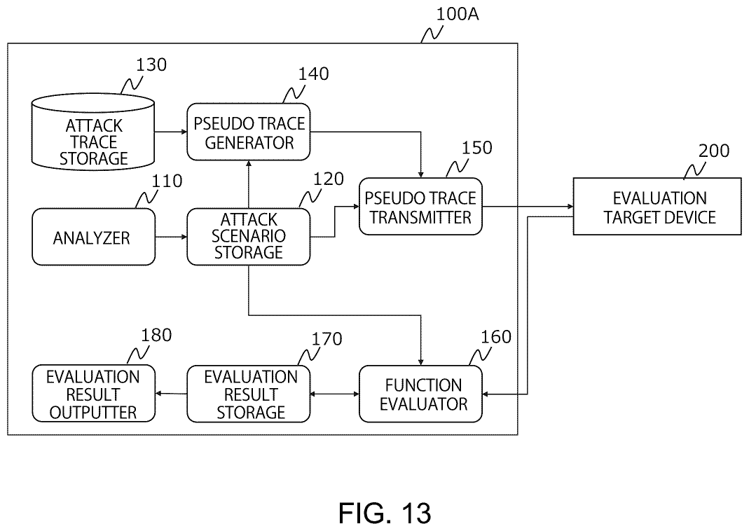

FIG. 13 is a block diagram illustrating a functional configuration of a security measure evaluation device 100A according to a second embodiment. Any block identical to that in the functional block diagram of FIG. 1 illustrating the configuration of the security measure evaluation device 100 according to the first embodiment is denoted by the same reference sign and detailed description thereof is omitted.

The security measure evaluation device 100A includes the analyzer 110, the attack scenario storage 120, the attack trace storage 130, the pseudo trace generator 140, the pseudo trace transmitter 150, a function evaluator (evaluator) 160, an evaluation result storage 170, and an evaluation result outputter 180. The function evaluator 160, the evaluation result storage 170, and the evaluation result outputter 180 are added to the security measure evaluation device of the first embodiment.

The function evaluator 160 receives output information based on a result of detection operation of the evaluation target device 200, evaluates whether an attack is detected or prevented based on the output information, and produces an evaluation result data 800. The output information may be a log of an intrusion detection (attack detection) application operating on an IDS or a log of an intrusion preventing (attack preventing) application operating on an IPS. Alternatively, the output information may be an operation log of an attack detection tool, which remains at a host in a case where the evaluation target device 200 is configured as attack detection tool software installed on the host.

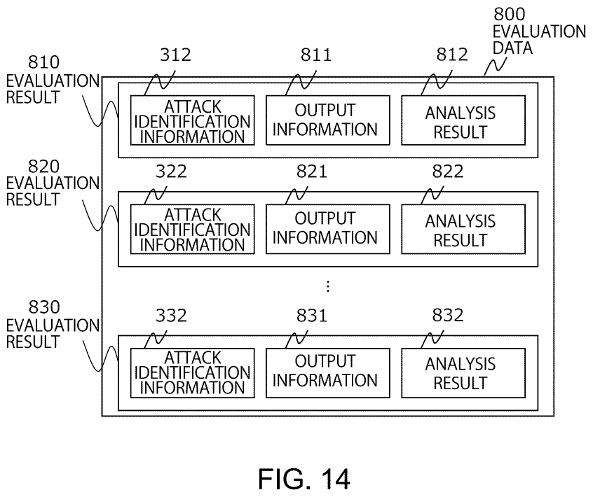

FIG. 14 illustrates an example of the evaluation result data 800. The evaluation result data 800 includes a plurality of evaluation results 810 to 830. The evaluation results 810 to 830 correspond to the attack data 310 to 330 of the attack scenario 300 in FIG. 4.

The evaluation result 810 includes the attack identification information 312 (refer to FIG. 4), output information 811, and an analysis result 812.

The output information 811 is information output from the evaluation target device 200 fed with a set of pieces of pseudo trace information (for example, pseudo trace information 612a″, 612b″, . . . ) transmitted in accordance with the attack data 310. The output information 811 may be a log of an intrusion detection or preventing application operating on an IDS or an IPS in a case where the evaluation target device 200 is the IDS or the IPS. The output information 811 may be an operation log of an attack detection tool at a host in a case where the evaluation target device 200 is the attack detection tool that runs on the host. In a case where the output information 811 is not obtained from the evaluation target device 200, the output information 811 does not need to be stored in the evaluation result 810.

The analysis result 812 is a result of evaluation of whether an attack is detected or prevented by the evaluation target device 200 based on the output information 811, and is generated by the function evaluator 160. The analysis result 812 may be, for example, data such as a string indicating that an attack is detected or prevented or an attack is not detected or prevented. The function evaluator 160 analyzes the output information 811 and stores a result of the analysis in the evaluation result 810 so that a user can easily understand whether an attack is detected or prevented. In a case where the output information 811 is not acquired from the evaluation target device 200, the function evaluator 160 may determine that the corresponding attack data in the attack scenario cannot be evaluated.

The evaluation result storage 170 stores the evaluation result data 800 produced by the function evaluator 160.

The evaluation result outputter 180 outputs the evaluation result data 800 stored in the evaluation result storage 170. The evaluation result outputter 180 may output part of the evaluation result data 800. For example, only an evaluation result indicating as analysis result 812 that an attack is not detected or prevented may be output among a plurality of evaluation results included in the evaluation result data 800. The evaluation result data 800 may output the evaluation result data 800 to a display device (for example, a console) or may output (write) the evaluation result data 800 to a file. The user can check the contents of the evaluation result data 800 by checking the evaluation result data 800 on a screen of the console or opening the file with a personal computer (PC) or the like.

### Processing Procedure

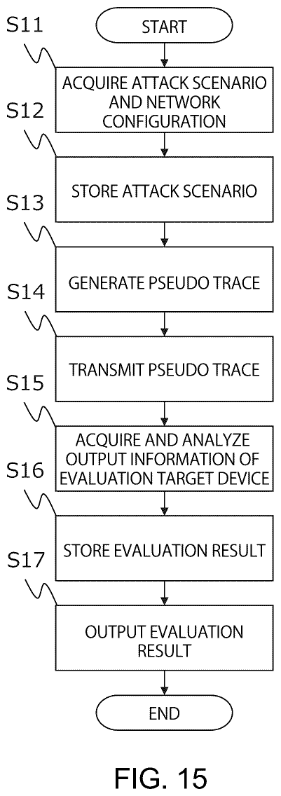

FIG. 15 is a flowchart illustrating an example of the procedure of processing by the security measure evaluation device 100A according to the second embodiment. Steps S11 to S14 are the same as in the procedure of processing by the security measure evaluation device 100 according to the first embodiment, and thus detailed description thereof is omitted.

The function evaluator 160 receives and analyzes output information from the evaluation target device 200 and generates the evaluation result data 800 including an evaluation result related to attack data of the attack scenario 300 (step S15 in FIG. 15).

The evaluation result storage 170 stores the evaluation result data 800 generated by the function evaluator 160 (step S16 in FIG. 15).

The evaluation result outputter 180 reads the evaluation result data 800 from the evaluation result storage 170 and outputs the evaluation result data 800 (step S17 in FIG. 15).

### Example 1 of Second Embodiment

In a case where the evaluation target device 200 is a network based IDS (hereinafter referred to as NIDS), pseudo trace information is generated based on communication data for a case where an attack is successful or unsuccessful, and whether the NIDS detects an attack corresponding to attack data is evaluated.

In the present example, the pseudo trace generator 140 generates pseudo communication data (pseudo trace information) based on attack data of the attack scenario 300 and attack trace data, and the pseudo trace transmitter 150 sends the pseudo trace information to the NIDS in accordance with the attack order. The function evaluator 160 acquires a log (output information) of a detection operation result from the NIDS.

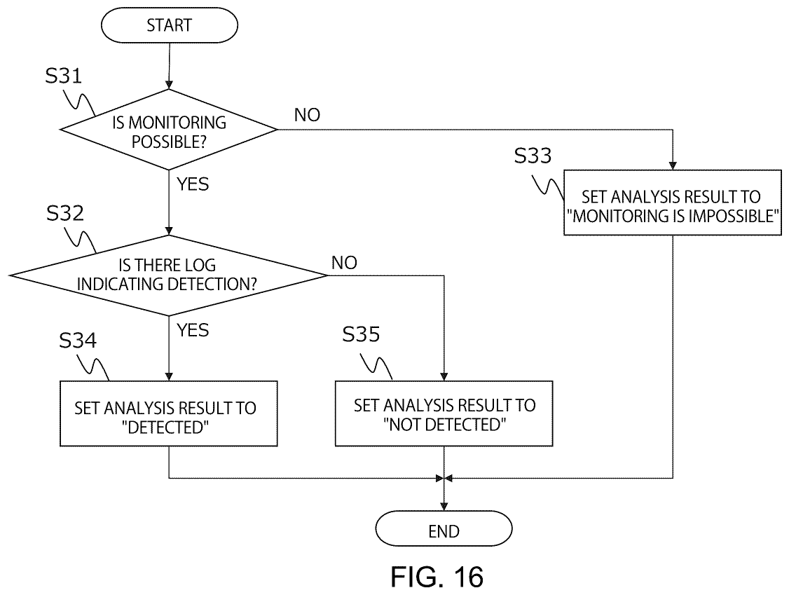

FIG. 16 is a flowchart illustrating an example of the processing procedure of generating the evaluation result 810 at the function evaluator 160 according to Example 1 of the second embodiment. The following description is made on an example of the processing procedure of generating the evaluation result 810 but is the same for the evaluation results 820 and 830.

First, the function evaluator 160 determines whether an attack based on the attack data 310 can be monitored by the NIDS (step S31 in FIG. 16). More specifically, it is determined whether an attack identified by the attack identification information 312 can be monitored by the NIDS. For example, whether a subnet in which the NIDS is deployed is the same as the subnet of an apparatus (monitoring target apparatus) specified by the parameters of the attack data is determined based on the parameters of the attack data. In a case where the subnets are different, the NIDS cannot receive packets flowing through a monitoring target subnet, and thus it may be determined that the monitoring is impossible. In a case where the monitoring is impossible, the analysis result 812 is set to information (for example, “monitoring is impossible”) indicating that the monitoring is impossible (step S33 in FIG. 16). In this example, it is determined by the function evaluator 160 that the monitoring is impossible and then the analysis result 812 is generated, but it may be understood based on the output information received from the evaluation target device 200 that the monitoring cannot be performed by the evaluation target device 200 and then the analysis result 812 may be generated.

In a case where the monitoring is possible, the function evaluator 160 determines whether the above-described attack is detected by the NIDS based on an acquired log or alert of the NIDS (step S32 in FIG. 16). When having determined that the above-described attack is detected, the function evaluator 160 sets the analysis result 812 to information (for example, “detected”) indicating the detection (step S34 in FIG. 16). For example, in a case where a particular string is included in the log or the alert, the function evaluator 160 may determine that the above-described attack is detected. The function evaluator 160 generates the evaluation result 810 including the analysis result 812, the attack identification information 312, and the output information 811.

When having determined that the above-described attack is not detected, the function evaluator 160 sets the analysis result 812 to information (for example, “not detected”) indicating the non-detection (step S35 in FIG. 16). For example, in a case where a particular string is included in the log or the alert, the function evaluator 160 may determine that the above-described attack is not detected. Alternatively, the function evaluator 160 may determine that no attack is detected in a case where no log nor alert is obtained. The function evaluator 160 generates the evaluation result 810 including the analysis result 812, the attack identification information 312, and the output information 811.

### Example 2 of Second Embodiment

In Example 1 of the second embodiment, it is assumed that the evaluation target device 200 is a network based IDS, but an attack can be detected but cannot be prevented by the network based IDS. The present example will be described for a case where the evaluation target device 200 is a network based IPS (hereinafter referred to as NIPS) capable of detecting and preventing an attack.

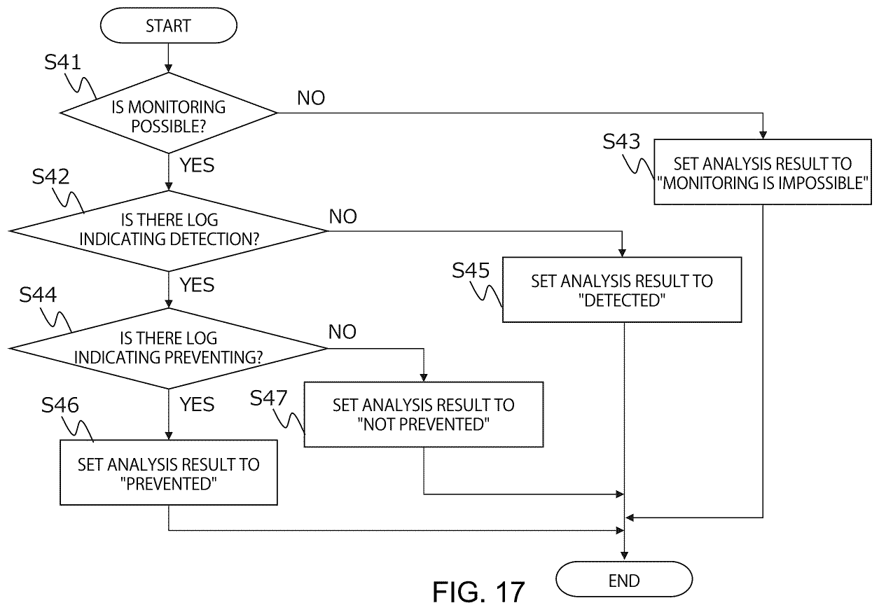

FIG. 17 is a flowchart illustrating an example of the processing procedure of acquiring the analysis result 812 from the output information 811 and generating the evaluation result 810 at the function evaluator 160 according to Example 2. The following description is made on an example of the processing procedure of generating the evaluation result 810 but is the same for the evaluation results 820 and 830.

First, the function evaluator 160 determines whether an attack based on the attack data 310 can be monitored by the NIPS (step S41 in FIG. 17). More specifically, it is determined that whether an attack identified by the attack identification information 312 can be monitored by the NIPS. Whether the monitoring is possible may be the same as in Example 1 described above. In a case where the monitoring is impossible, the analysis result 812 is set to information (for example, “monitoring is impossible”) indicating that the monitoring is impossible (step S43 in FIG. 17).

In a case where the above-described attack can be monitored, the function evaluator 160 determines whether the above-described attack is detected based on the acquired log or alert of the NIPS (step S42 in FIG. 17). When having determined that the attack is not detected, the function evaluator 160 sets the analysis result 812 to information (for example, “not detected”) indicating that the above-described attack is not detected (step S45 in FIG. 17). The function evaluator 160 generates the evaluation result 810 including the analysis result 812, the attack identification information 312, and the output information 811.

When having determined that the above-described attack is detected, the function evaluator 160 determines whether the above-described attack is prevented based on the log or alert of the NIPS (step S44 in FIG. 17). When having determined that the above-described attack is prevented, the function evaluator 160 sets the analysis result 812 to information (for example, “prevented”) indicating that the above-described attack is prevented (step S46 in FIG. 17). When having determined that the above-described attack is not prevented, the function evaluator 160 sets the analysis result 812 to information (for example, “not prevented”) indicating that the above-described attack is not prevented (step S47 in FIG. 17). For example, in a case where a particular string is included in the log or the alert, the function evaluator 160 may determine that the above-described attack is prevented or not prevented. The function evaluator 160 generates the evaluation result 810 including the analysis result 812, the attack identification information 312, and the output information 811.

### Example 3 of Second Embodiment

In Examples 1 and 2 of the second embodiment, the evaluation target device 200 is a network based IDS or a network based IPS and communication data is used as pseudo trace information. The present example will be described for a case where the evaluation target device 200 is an attack detection tool (log detection tool) that uses a log and the log is used as pseudo trace information. For example, the attack detection tool may be implemented on the GW 11 or the apparatus 12 in a case of the network configuration as in FIG. 2.

In the present example, the pseudo trace generator 140 generates a pseudo host log based on attack data of the attack scenario 300 and attack trace data. The pseudo trace transmitter 150 transmits the host log to the evaluation target device 200 in the attack order, thereby sending the host log to the evaluation target device 200 (attack detection tool). The function evaluator 160 acquires output information of the attack detection tool from the evaluation target device 200.

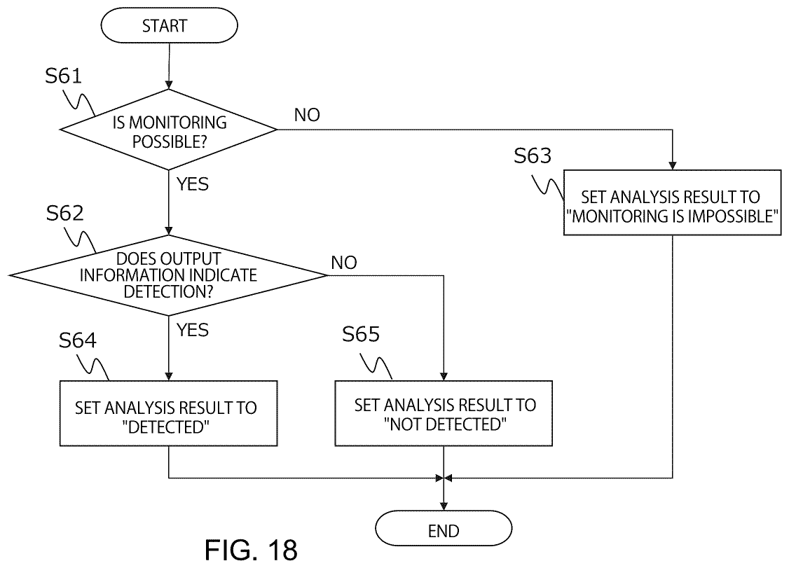

FIG. 18 is a flowchart illustrating an example of the processing procedure of acquiring the analysis result 812 from the output information 811 and generating the evaluation result 810 at the function evaluator 160 according to Example 3 of the second embodiment. The following description is made on an example of the processing procedure of generating the evaluation result 810 but is the same for the evaluation results 820 and 830.

First, the function evaluator 160 determines whether the attack data 310 can be monitored by the attack detection tool (step S61 in FIG. 18). For example, in a case where a monitoring target specified by parameters is a host on which the attack detection tool is installed (in a case of an offline attack detection tool), it is determined that an attack on the host can be monitored. In a case where the monitoring target specified by the attack identification information or parameters is a host on which the attack detection tool is not installed, it may be determined that the monitoring is impossible. In a case where the monitoring is impossible, the analysis result 812 is set to information (for example, “monitoring is impossible”) indicating that the above-described attack cannot be monitored (step S63 in FIG. 18).

In a case where the above-described attack can be monitored, the function evaluator 160 determines whether the attack is detected based on the acquired output information of the attack detection tool (step S62 in FIG. 18). When having determined that the attack is detected, the function evaluator 160 sets the analysis result 812 to information (for example, “detected”) indicating that the above-described attack is detected (step S64 in FIG. 18). The function evaluator 160 generates the evaluation result 810 including the analysis result 812, the attack identification information 312, and the output information 811.

When having determined that the above-described attack is not detected, the function evaluator 160 sets the analysis result 812 to information (for example, “not detected”) indicating that the above-described attack is not detected (step S65 in FIG. 18). For example, in a case where a particular string is included in the output information of the attack detection tool, the function evaluator 160 may determine that the above-described attack is detected or not detected. Whether the attack is detected may be manually determined or may be determined in accordance with an optional algorithm. The function evaluator 160 generates the evaluation result 810 including the analysis result 812, the attack identification information 312, and the output information 811.

The exemplary operation in a case where the evaluation target device 200 is a network based IDS, a network based IPS, or an attack detection tool is described above in each of Examples 1 to 3 of the second embodiment, respectively, but any other example is possible. For example, the evaluation target device 200 may be a host based IDS, a host based IPS, a firewall, a web application firewall (WAF), or a personal firewall.

### (Hardware Configuration)

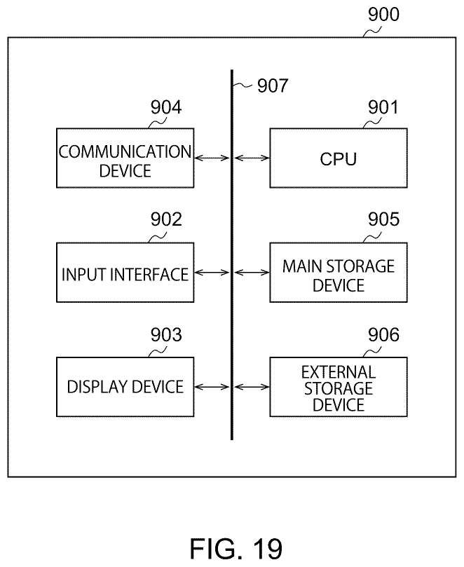

FIG. 19 illustrates a hardware configuration of the information processing device according to each embodiment. The information processing device is configured as a computer device 900. The computer device 900 includes a CPU 901, an input interface 902, a display device 903, a communication device 904, a main storage device 905, and an external storage device 906, and these components are mutually connected through a bus 907.

The CPU (central processing unit) 901 executes an information processing program as a computer program on the main storage device 905. The information processing program is a computer program configured to achieve each above-described functional composition of the present device. The information processing program may be achieved by a combination of a plurality of computer programs and scripts instead of one computer program. Each functional composition is achieved as the CPU 901 executes the information processing program.

The input interface 902 is a circuit for inputting, to the present device, an operation signal from an input device such as a keyboard, a mouse, or a touch panel. The input interface 902 corresponds to the input device in each embodiment.

The display device 903 displays data output from the present device. The display device 903 is, for example, a liquid crystal display (LCD), an organic electroluminescence display, a cathode-ray tube (CRT), or a plasma display (PDP) but is not limited thereto. Data output from the computer device 900 can be displayed on the display device 903. The display device 903 corresponds to the output device in each embodiment.

The communication device 904 is a circuit for the present device to communicate with an external device in a wireless or wired manner. Data can be input from the external device through the communication device 904. The data input from the external device can be stored in the main storage device 905 or the external storage device 906.

The main storage device 905 stores, for example, the information processing program, data necessary for execution of the information processing program, and data generated through execution of the information processing program. The information processing program is loaded and executed on the main storage device 905. The main storage device 905 is, for example, a RAM, a DRAM, or an SRAM but is not limited thereto. Each storage or database in the information processing device in each embodiment may be implemented on the main storage device 905.

The external storage device 906 stores, for example, the information processing program, data necessary for execution of the information processing program, and data generated through execution of the information processing program. The information processing program and the data are read onto the main storage device 905 at execution of the information processing program. The external storage device 906 is, for example, a hard disk, an optical disk, a flash memory, or a magnetic tape but is not limited thereto. Each storage or database in the information processing device in each embodiment may be implemented on the external storage device 906.

The information processing program may be installed on the computer device 900 in advance or may be stored in a storage medium such as a CD-ROM. Moreover, the information processing program in each embodiment may be uploaded on the Internet.

The present device may be configured as a single computer device 900 or may be configured as a system including a plurality of mutually connected computer devices 900.

While certain embodiment have been described, these embodiment have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The embodiments as described before may be configured as below.

### (Clauses)

Clause 1. An information processing device comprising:
a pseudo trace generator configured to employ trace information of a first attack acquired when the first attack is executed on a first apparatus in a communication network and attack method information related to an attack method of a second attack on a second apparatus to generate pseudo trace information of the second attack; and
a pseudo trace transmitter configured to transmit the pseudo trace information of the second attack to an evaluation target device which detects an attack based on trace information of the attack.

Clause 2. The information processing device according to claim 1, wherein
the attack method information related to the attack method of the second attack includes a parameter related to the second attack, and
the pseudo trace generator generates the pseudo trace information of the second attack by rewriting the trace information of the first attack based on the parameter.

Clause 3. The information processing device according to claim 2, wherein
the second apparatus is an apparatus different from or identical to the first apparatus,
the trace information of the first attack includes information related to the first apparatus,
the parameter includes information related to the second apparatus, and
the pseudo trace generator generates the pseudo trace information of the second attack by rewriting the information related to the first apparatus, the information being included in the trace information of the first attack, with the information related to the second apparatus based on the parameter.

Clause 4. The information processing device according to claim 3, wherein
the trace information of the first attack further includes time information at the first attack, and
the pseudo trace generator generates the pseudo trace information of the second attack by further rewriting time information at the first attack, the time information being included in the trace information of the first attack, with time information at a current time.

Clause 5. The information processing device according to claim 3 or 4, wherein
the information related to the first apparatus includes address information of the first apparatus,
the parameter includes address information of the second apparatus as the information related to the second apparatus, and
the pseudo trace generator rewrites the address information of the first apparatus with the address information of the second apparatus.

Clause 6. The information processing device according to any one of claims 1 to 5, wherein
the pseudo trace generator
   selects one of a plurality of attack scenarios including the attack method information related to the attack method of the second attack and attack identification information identifying the attack method of the second attack and
   selects attack trace data including attack identification information matching the attack identification information included in the selected attack scenario from among a plurality of pieces of attack trace data including the trace information of the first attack and attack identification information identifying an attack method of the first attack, and
the pseudo trace generator generates the pseudo trace information of the second attack based on
   the trace information of the first attack included in the selected attack trace data and
   the attack method information related to the attack method in the selected attack scenario.

Clause 7. The information processing device according to any one of claims 1 to 6, wherein
the evaluation target device is a device configured to acquire communication data flowing through the communication network at an attack and detect or prevent the attack based on the acquired communication data, and
the trace information of the first attack is communication data flowing through the communication network at the first attack and acquired from the communication network.

Clause 8. The information processing device according to any one of claims 1 to 7, wherein
the trace information of the first attack is an operation log acquired by the first apparatus at the first attack, and
the evaluation target device is a device configured to detect an attack based on an operation log acquired at the attack as trace information of the attack by an apparatus targeted by the attack.

Clause 9. The information processing device according to any one of claims 1 to 8, further comprising an evaluator configured to receive, from the evaluation target device, output information indicating a detection result of the second attack based on the pseudo trace information of the second attack and
generate an analysis result indicating whether the second attack is detected by the evaluation target device based on the output information.

Clause 10. The information processing device according to claim 9, wherein
the pseudo trace generator
   selects one of a plurality of attack scenarios including a parameter related to the second attack and attack identification information identifying the attack method of the second attack and
   selects attack trace data including attack identification information matching the attack identification information included in the selected attack scenario from among a plurality of pieces of attack trace data including the trace information of the first attack and attack identification information identifying an attack method of the first attack,
the pseudo trace generator generates the pseudo trace information of the second attack based on the trace information of the first attack included in the selected attack trace data and the parameter included in the attack scenario,
the evaluator specifies the attack identification information included in the attack scenario based on which the pseudo trace information of the second attack is generated, and
the evaluator
   generates an evaluation result including a set of the analysis result, the output information, and the specified attack identification information and
   outputs the evaluation result.

Clause 11. The information processing device according to any one of claims 1 to 10, wherein trace information of the first attack is trace information acquired when an attack is successful at the first attack.

Clause 12. The information processing device according to any one of claims 1 to 11, wherein trace information of the first attack is trace information acquired when an attack is unsuccessful at the first attack.

Clause 13. An information processing method comprising:
employing trace information of a first attack acquired when the first attack is executed on a first apparatus in a communication network and information related to an attack method of a second attack on a second apparatus and generating pseudo trace information of the second attack; and
transmitting the pseudo trace information of the second attack to an evaluation target device which detects an attack based on trace information of the attack.

1. An information processing device comprising:
a pseudo trace generator configured to employ trace information of a first attack acquired when the first attack is executed on a first apparatus in a communication network and attack method information related to an attack method of a second attack on a second apparatus to generate pseudo trace information of the second attack; and
a pseudo trace transmitter configured to transmit the pseudo trace information of the second attack to an evaluation target device which detects an attack based on trace information of the attack.

2. The information processing device according to claim 1, wherein
the attack method information related to the attack method of the second attack includes a parameter related to the second attack, and
the pseudo trace generator generates the pseudo trace information of the second attack by rewriting the trace information of the first attack based on the parameter.

3. The information processing device according to claim 2, wherein
the second apparatus is an apparatus different from or identical to the first apparatus,
the trace information of the first attack includes information related to the first apparatus,
the parameter includes information related to the second apparatus, and
the pseudo trace generator generates the pseudo trace information of the second attack by rewriting the information related to the first apparatus, the information being included in the trace information of the first attack, with the information related to the second apparatus based on the parameter.

4. The information processing device according to claim 3, wherein
the trace information of the first attack further includes time information at the first attack, and
the pseudo trace generator generates the pseudo trace information of the second attack by further rewriting time information at the first attack, the time information being included in the trace information of the first attack, with time information at a current time.

5. The information processing device according to claim 3, wherein
the information related to the first apparatus includes address information of the first apparatus,
the parameter includes address information of the second apparatus as the information related to the second apparatus, and
the pseudo trace generator rewrites the address information of the first apparatus with the address information of the second apparatus.

6. The information processing device according to claim 1, wherein
the pseudo trace generator
selects one of a plurality of attack scenarios including the attack method information related to the attack method of the second attack and attack identification information identifying the attack method of the second attack and
selects attack trace data including attack identification information matching the attack identification information included in the selected attack scenario from among a plurality of pieces of attack trace data including the trace information of the first attack and attack identification information identifying an attack method of the first attack, and
the pseudo trace generator generates the pseudo trace information of the second attack based on
the trace information of the first attack included in the selected attack trace data and
the attack method information related to the attack method in the selected attack scenario.

7. The information processing device according to claim 1, wherein
the evaluation target device is a device configured to acquire communication data flowing through the communication network at an attack and detect or prevent the attack based on the acquired communication data, and
the trace information of the first attack is communication data flowing through the communication network at the first attack and acquired from the communication network.

8. The information processing device according to claim 1, wherein
the trace information of the first attack is an operation log acquired by the first apparatus at the first attack, and
the evaluation target device is a device configured to detect an attack based on an operation log acquired at the attack as trace information of the attack by an apparatus targeted by the attack.

9. The information processing device according to claim 1, further comprising an evaluator configured to receive, from the evaluation target device, output information indicating a detection result of the second attack based on the pseudo trace information of the second attack and
generate an analysis result indicating whether the second attack is detected by the evaluation target device based on the output information.

10. The information processing device according to claim 9, wherein
the pseudo trace generator
selects one of a plurality of attack scenarios including a parameter related to the second attack and attack identification information identifying the attack method of the second attack and
selects attack trace data including attack identification information matching the attack identification information included in the selected attack scenario from among a plurality of pieces of attack trace data including the trace information of the first attack and attack identification information identifying an attack method of the first attack,
the pseudo trace generator generates the pseudo trace information of the second attack based on the trace information of the first attack included in the selected attack trace data and the parameter included in the attack scenario,
the evaluator specifies the attack identification information included in the attack scenario based on which the pseudo trace information of the second attack is generated, and
the evaluator
generates an evaluation result including a set of the analysis result, the output information, and the specified attack identification information and
outputs the evaluation result.

11. The information processing device according to claim 1, wherein trace information of the first attack is trace information acquired when an attack is successful at the first attack.

12. The information processing device according to claim 1, wherein trace information of the first attack is trace information acquired when an attack is unsuccessful at the first attack.

13. An information processing method comprising:
employing trace information of a first attack acquired when the first attack is executed on a first apparatus in a communication network and information related to an attack method of a second attack on a second apparatus and generating pseudo trace information of the second attack; and
transmitting the pseudo trace information of the second attack to an evaluation target device which detects an attack based on trace information of the attack.
